(19) United States
(12) Patent Application Publication
(10) Pub. No.: US 2016/0216435 A1
(43) Pub. Date: Jul. 28, 2016

(54) CURVED DISPLAY DEVICE

(71) Applicant: SAMSUNG DISPLAY CO., LTD., Yongin Si (KR)

(72) Inventors: Chan-jae Park, Osan-si (KR); Taeho Lee, Seoul (KR); Seki Park, Hwaseong-si (KR); Sangho Hwang, Suwon-si (KR)

(21) Appl. No.: 15/004,205

(22) Filed: Jan. 22, 2016

(30) Foreign Application Priority Data
Jan. 23, 2015 (KR) 10-2015-0011527

(51) Int. Cl. F21V 8/00

(52) U.S. Cl. CPC G02B 6/0078; G02B 6/0028; G02B 6/0055

(57) ABSTRACT

A curved display device includes a display panel having a curved shape and including a display area having a curved surface, and a backlight assembly providing a light to the display panel. The backlight assembly includes at least one light source arranged to emit the light and a light guiding member positioned and arranged to guide the light to the display panel. The light guiding member includes at least two light guiding parts spaced apart from each other with a gap therebetween, the light source being disposed in the gap.

### CROSS-REFERENCE TO RELATED APPLICATION

This U.S. non-provisional patent application claims priority under 35 U.S.C. §119 to Korean Patent Application No. 10-2015-0011527 filed on Jan. 23, 2015, the contents of which are hereby incorporated by reference in their entirety.

### BACKGROUND

1. Field of Disclosure

Embodiments of the present disclosure relates to a curved display device. More particularly, embodiments of the present disclosure relate to a curved display device having a curved display area.

2. Description of the Related Art

Flat panel display devices have found wide use in various information-processing devices, such as television sets, monitors, notebook computers, mobile phones, and the like. In recent years, a curved display device having a curved display area has been developed. The curved display device provides images having improved three-dimensional effects, sense of immersion (or immersiveness), and presence to a viewer.

### SUMMARY

Embodiments of the present disclosure provide a curved display device having a slim bezel.

Embodiments of the inventive concept provide a curved display device including a display panel having a curved shape and including a display area having a curved surface, and a backlight assembly arranged to provide light to the display panel. The backlight assembly includes at least one light source arranged to emit the light, and a light guiding member positioned and arranged to guide the light to the display panel. The light guiding member includes at least two light guiding parts spaced apart from each other with a gap therebetween, the light source being disposed in the gap.

The light guiding member includes a first light guiding part disposed at one side of the light source, and a second light guiding part disposed at an opposing side of the light source.

Each of the first and second light guiding parts includes a light incident surface and an opposite surface facing the light incident surface, and each of the first and second light guiding parts has a thickness that decreases as a distance from the opposite surface decreases.

Each of the first and second light guiding parts comprises substantially flat or planar surfaces.

Each of the first and second light guiding parts is positioned so as to form an included angle that is an oblique angle.

The display panel has the curved shape bent along a first direction and each of the first and second light guiding parts is substantially parallel to a direction oblique to the first direction when viewed in a side view.

The backlight assembly includes a printed circuit board on which the light source is mounted and an accommodating member accommodating the light source, the light guiding member, and the printed circuit board, and the printed circuit board overlaps an area between the first light guiding part and the second light guiding part.

The accommodating member includes bottom portions and a plurality of sidewalls extending from the bottom portions, and the bottom portions include a first bottom portion facing the first light guiding part, a second bottom portion facing the second light guiding part, and a center bottom portion connecting the first bottom portion and the second bottom portion and facing the printed circuit board.

Each of the first and second bottom portions is inclined with respect to the center bottom portion so as to form an included angle between the first and second bottom portions, the included angle being an oblique angle.

The display panel has the curved shape bent along a first direction and each of the first and second light guiding parts is substantially parallel to a direction oblique to the first direction when viewed in a side view.

The backlight assembly further includes a reflection plate disposed between the accommodating member and the light guiding member. The reflection plate includes a first reflection part disposed between the first bottom portion and the first light guiding part, and a second reflection part disposed between the second bottom portion and the second light guiding part.

The backlight assembly further includes at least one optical member, the at least one optical member being disposed between the display panel and the light guiding member to have the curved shape and being arranged to direct light exiting from the light guiding member and incident to the display panel.

The backlight assembly further includes a reflection member overlapping an area between the first light guiding part and the second light guiding part to cover the light source, and a supporting member disposed between the reflection member and the optical member to support the optical member.

The backlight assembly further includes an optical lens disposed in the gap between the first light guiding part and the second light guiding part, so as to cover the light source and to be arranged to refract the light toward the first and second light guiding parts, and a reflection member overlapping the gap so as to cover the optical lens.

The backlight assembly further includes a reflective covering member covering edges of the first and second light guiding parts which face each other, and including a reflection surface inclined with respect to a light exit surface of the light source so as to reflect the light emitted from the light source toward the first and second light guiding parts.

The backlight assembly further includes an auxiliary supporting member disposed in the gap, and a reflection member overlapping the gap so as to cover the light source. The auxiliary supporting member includes an inclined surface facing a surface of the light guiding member, and the printed circuit board is disposed on the inclined surface.

The backlight assembly further includes a diffusion member covering ends of the first and second light guiding parts which face each other.

The diffusion member includes a base part and light scattering parts disposed on the base part, and a spatial density of the light scattering parts in a first area of the base part corresponding to a position of the light source is greater than a spatial density of the light scattering parts in an area of the base part outside the first area.

Embodiments of the inventive concept provide a curved display device including a display panel having a curved shape and including a display area having a curved surface, and a backlight assembly arranged to provide light to the display panel. The backlight assembly includes a plurality of light sources arranged substantially parallel to a side of the display panel and constructed to emit the light, and a light guiding member positioned and arranged to guide the light to the display panel. The light guiding member has a thickness that decreases with distance from the plurality of light sources.

The light guiding member includes a first light guiding part disposed at one side of the light sources, and a second light guiding part disposed at an opposing side of the light sources. Each of the first and second light guiding parts includes a light incident surface and an opposite surface facing the light incident surface, and a thickness of each of the first and second light guiding parts decreases as a distance from its corresponding opposite surface decreases.

Each of the first and second light guiding parts is positioned so as to form an included angle that is an oblique angle.

The display panel has the curved shape bent along a first direction and each of the first and second light guiding parts is substantially parallel to a direction oblique to the first direction when viewed in a side view.

The backlight assembly further includes a printed circuit board having the light sources mounted thereon and overlapping an area between the first light guiding part and the second light guiding part, and an accommodating member accommodating the light sources, the light guiding member, and the printed circuit board. The accommodating member includes a first bottom portion facing the first light guiding part, a second bottom portion facing the second light guiding part, and a center bottom portion connecting the first bottom portion and the second bottom portion and facing the printed circuit board.

Each of the first and second bottom portions is inclined with respect to the center bottom portion.

The backlight assembly further includes a reflection plate disposed between the bottom portions of the accommodating member and the light guiding member. The reflection plate includes a first reflection part disposed between the first bottom portion and the first light guiding part, and a second reflection part disposed between the second bottom portion and the second light guiding part.

The backlight assembly further includes at least one optical member disposed between the display panel and the light guiding member to have the curved shape and being arranged to direct the light exiting from the light guiding member and incident to the display panel, a reflection member overlapping an area between the first light guiding part and the second light guiding part to cover the light sources, and a supporting member disposed between the reflection member and the optical member to support the optical member.

According to the above, the backlight assembly of a curved display device is realized using light guide parts spaced apart from each other, with the light sources disposed between the light guide parts. In addition, since each light guide part has a wedge shape, the edges of the curved display device are thinner.

In addition, the light emitting unit, including the light sources, is disposed to overlap the display area of the curved display device. Therefore, light sources need not be present at the edges of the display, and thus the thickness of edges of the curved display device is reduced.

Further, each of the light guiding parts of the light guiding member has an incident surface facing the light sources and an opposite surface facing the incident surface, and thus the outer edges of the light guide parts may be made slimmer. In other words, since the area of the incident surface is irrelevant to the slimness of the light guiding member, the area of the incident surface becomes greater and light incident efficiency of the light from the light sources is improved. That is, the thickness of the edge part of the light guiding member is not necessary to improve the light incident efficiency, and thus the light guide member may be made slimmer at its outer edges.

### BRIEF DESCRIPTION OF THE DRAWINGS

The above and other advantages of the present disclosure will become readily apparent by reference to the following detailed description when considered in conjunction with the accompanying drawings wherein:

FIG. 1A is a perspective view showing a curved display device according to an exemplary embodiment of the present disclosure;

FIG. 1B is a top view showing the curved display device shown in FIG. 1A;

FIG. 2 is an exploded perspective view showing the curved display device shown in FIG. 1A;

FIG. 3A is a cross-sectional view taken along a line I-I′ of FIG. 2;

FIG. 3B is a perspective view partially showing a coupling state between a light guiding member and a light emitting unit shown in FIG. 2;

FIG. 3C is an enlarged view showing the light guiding member and the light emitting unit shown in FIG. 3A;

FIG. 4 is a cross-sectional view showing a light emitting unit and a light guiding member of a curved display device according to another exemplary embodiment of the present disclosure;

FIG. 5 is a cross-sectional view showing a light emitting unit and a light guiding member of a curved display device according to another exemplary embodiment of the present disclosure;

FIGS. 6A and 6B are views showing a light emitting unit and a light guiding member of a curved display device according to another exemplary embodiment of the present disclosure; and

FIG. 7 is a cross-sectional view showing a light emitting unit and a light guiding member of a curved display device according to another exemplary embodiment of the present disclosure.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All numerical values are approximate, and may vary. All examples of specific materials and compositions are to be taken as nonlimiting and exemplary only. Other suitable materials and compositions may be used instead.

Hereinafter, the present invention will be explained in detail with reference to the accompanying drawings.

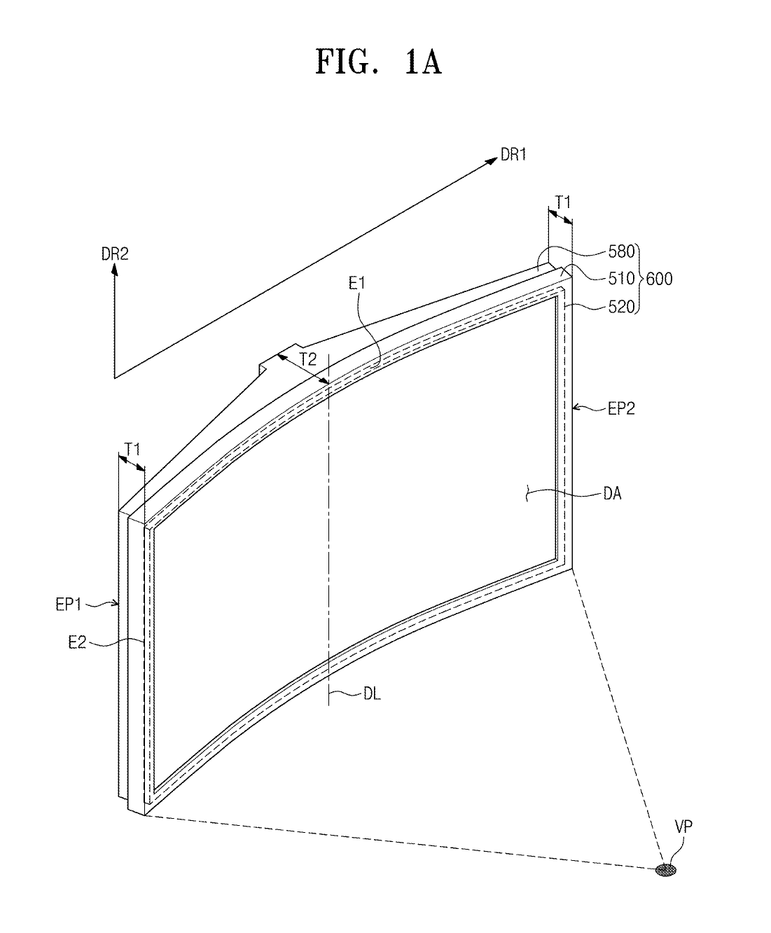

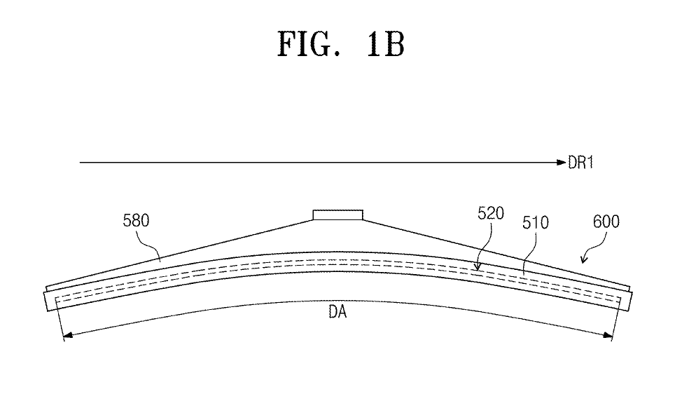

FIG. 1A is a perspective view showing a curved display device 600 according to an exemplary embodiment of the present disclosure, and FIG. 1B is a top view showing the curved display device shown in FIG. 1A.

Referring to FIGS. 1A and 1B, the curved display device 600 is bent along a first direction DR1 and provided with a display area DA having a curved shape. Thus, the curved display device 600 provides an image having improved three-dimensional effect, sense of immersion (or immersiveness), and presence to a viewer.

In the present exemplary embodiment, a viewpoint VP of the viewer is defined in front of the curved display device 600, and the display area DA has a concave-curved shape when viewed from the viewpoint VP. In another exemplary embodiment, the display area DA may have a convex-curved shape as viewed relative to, or from, the viewpoint VP.

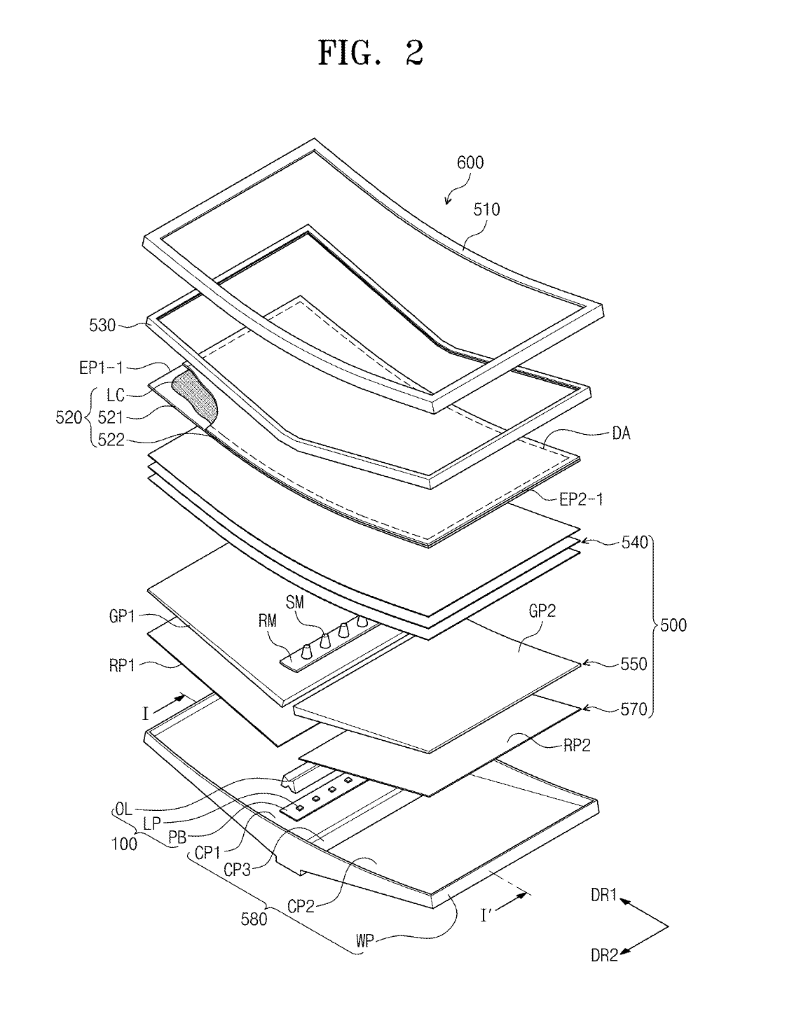

The curved display device 600 includes an accommodating member 580, a display panel 520, a backlight assembly 500 (refer to FIG. 2), and a covering member 510.

In the present exemplary embodiment, the display panel 520 is a liquid crystal display panel that displays an image using light generated by the backlight assembly. However, the display panel 520 should not be limited to a liquid crystal display panel. That is, the display panel 520 may be any other type of display, such as an organic light emitting diode display panel, a nanocrystal display panel, an electrophoretic display panel, or an electrowetting display panel.

The display panel 520 is bent along the first direction DR1. Thus, long sides E1 of the display panel 520 extend in a curved line shape along the first direction DR1 and short sides of the display panel 520 extend in a straight line shape along a second direction DR2 substantially perpendicular to the first direction DR1.

The accommodating member 580 accommodates the display panel 520 therein, and the covering member 510 is coupled to the accommodating member 580 in which the display panel 520 is accommodated. The covering member 510 has an opening formed therethrough to correspond to the display area DA, and covers edges of the display panel 520. Thus, the display area DA is exposed to an outside of the curved display device 600, to be viewed by users.

The curved display device 600 includes a first edge EP1, and a second edge EP2 facing the first edge EP1 and positioned at an opposite side of display device 600. A reference line DL is defined substantially parallel to the second direction DR2 to divide the display area DA into two areas. In this case, a first thickness T1 (i.e. width) of each of the first and second edges EP1 and EP2 is smaller than a second thickness T2 of the curved display device 600 at a position corresponding to the first reference line DL.

In the present exemplary embodiment, the first thickness T1 is from about 10% to about 70% of a size of the second thickness T2. For instance, the second thickness T2 may be about 15 mm and the first thickness T1 may be about 5 mm.

Hereinafter, a structure of the curved display device 600, including slim first and second edges EP1 and EP2, will be described in detail.

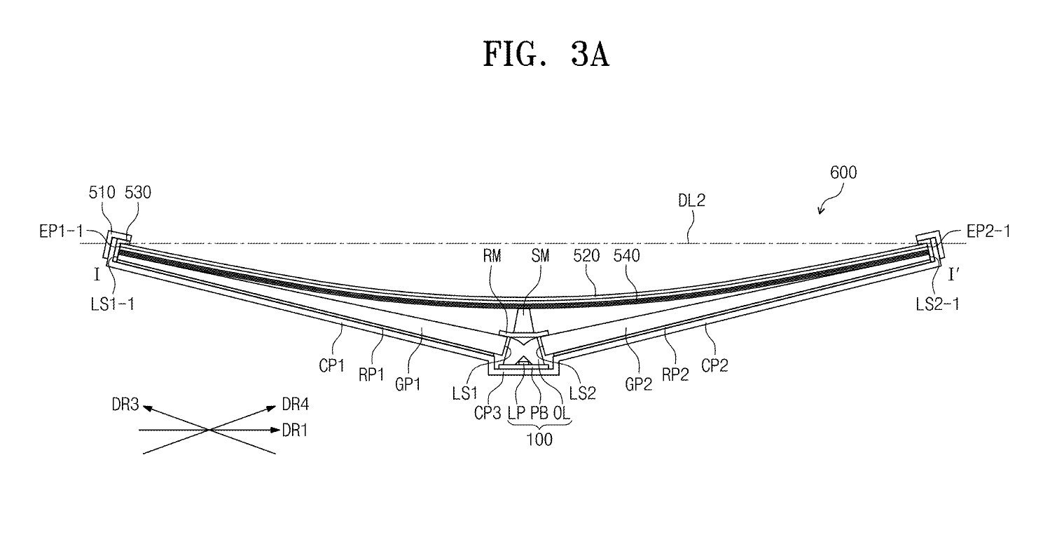

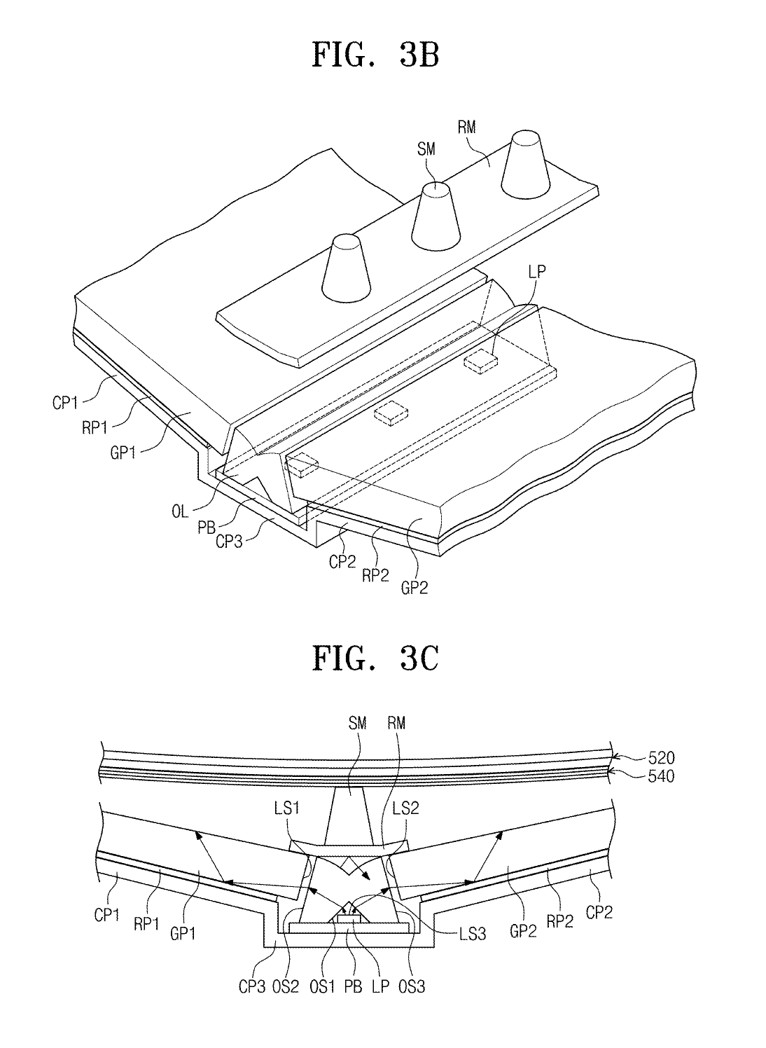

FIG. 2 is an exploded perspective view of the curved display device shown in FIG. 1A, FIG. 3A is a cross-sectional view taken along a line I-I′ of FIG. 2, FIG. 3B is a perspective view partially showing a coupling state between a light guiding member and a light emitting unit shown in FIG. 2, and FIG. 3C is an enlarged view showing the light guiding member and the light emitting unit shown in FIG. 3A.

Referring to FIGS. 2, 3A, 3B, and 3C, the accommodating member 580 accommodates elements of the backlight assembly 500. In the present exemplary embodiment, the accommodating member 580 includes a plurality of bottom portions and a plurality of sidewalls WP extending from the bottom portions to provide a containing space, and the bottom portions include a first bottom portion CP1, a second bottom portion CP2, and a center bottom portion CP3.

The first bottom portion CP1 faces a first light guiding part GP1 of a light guiding member 550 and the second bottom portion CP2 faces a second light guiding part GP2 of the light guiding member 550. In addition, the center bottom portion CP3 connects the first bottom portion CP1 to the second bottom portion CP2 and the center bottom portion CP3 faces a printed circuit board PB.

In the present exemplary embodiment, each of the first and second bottom portions CP1 and CP2 has an inclined shape with respect to the center bottom portion CP3 when viewed in a side view. More particularly, as shown in FIG. 3A, the center bottom portion CP3 is arranged substantially parallel to the first direction DR1, and the first bottom portion CP1 is arranged substantially parallel to a third direction DR3, which is oblique to the first direction DR1. The second bottom portion CP2 is arranged substantially parallel to a fourth direction DR4, which is oblique to the first direction DR1, and the fourth direction DR4 crosses the third direction DR3.

In addition, when a first edge part EP1-1, a second edge part EP2-1 facing the first edge part EP1-1, and a second reference line DL2 connecting endpoints of the first and second edge parts EP1-1 and EP2-1 are defined in the display panel 520, each of the first and second bottom portions CP1 and CP2 is inclined with respect to the second reference line DL2. Thus, the bottom portions CP1 and CP2 are oriented so that they form an included oblique angle.

The display panel 520 is bent along the first direction DR1 to conform to the bottom portions CP1 and CP2, so that its edges also form the included oblique angle. The display panel 520 includes a first substrate 521, a second substrate 522, and a liquid crystal layer LC interposed between the first substrate 521 and the second substrate 522.

The first substrate 521 includes a plurality of pixels, each including a pixel electrode (not shown) and a thin film transistor (not shown) switching a driving signal applied to the pixel electrode. The second substrate 522 includes a common electrode (not shown) and a color filter (not shown). The common electrode and the pixel electrode together form an electric field applied to the liquid crystal layer LC, and the color filter filters the light generated from the backlight assembly 500 to produce a modulated and colored light.

The first and second substrates 521 and 522 should not limited to the structure described herein, and other structures are contemplated. For instance, the first substrate 521 may further include the common electrode in addition to the pixel electrode, or the first substrate 521 may further include the color filter.

The backlight assembly 500 is accommodated in the accommodating member 580 and generates the light used by the display panel 520 to produce images. The backlight assembly 500 includes a light emitting unit 100, the light guiding member 550, a reflection plate 570, a plurality of supporting members SM, and an optical member 540.

The light emitting unit 100 includes a plurality of light sources LP, a printed circuit board PB, and an optical lens OL.

The light sources LP generate light. The light sources LP are arranged along an area between the first light guiding part GP1 and the second light guiding part GP2. Also, the light sources LP are arranged along the second direction DR2 substantially parallel to the short sides E2 (refer to FIG. 1A) of the display panel 520.

The light sources LP are arranged adjacent to a first light incident surface LS1 of the first light guiding part GP1 and a second light incident surface LS2 of the second light guiding part GP2. Thus, the light emitted from the light sources LP is incident to the first and second light guiding parts GP1 and GP2 through the first and second light incident surfaces LS1 and LS2.

In the present exemplary embodiment, each of the light sources LP may be, but is not limited to, a light emitting diode (LED) package including a light emitting diode. Each of the light sources LP has a top emission type structure, in which a light exit surface LS3 of the light sources LP faces an upper direction (e.g., normal to the surface of display panel 520 that it faces).

The printed circuit board PB includes the light sources LP mounted thereon, and applies a source voltage to the light sources LP. The printed circuit board PB extends in the second direction DR2 and is positioned in the area between the first and second light guiding parts GP1 and GP2, such that the printed circuit board PB is disposed on the center bottom portion CP3 of the accommodating member 580.

The optical lens OL is disposed between the first and second light guiding parts GP1 and GP2 to cover the light sources LP. The optical lens OL refracts the light emitted from the light sources LP toward the first and second light guiding parts GP1 and GP2.

The optical lens OL extends in the second direction DR2 and includes a first optical surface OS1, a second optical surface OS2, and a third optical surface OS3. The first optical surface OS1 is defined on a bottom part of the optical lens OL to face the light exit surface LS3, the second optical surface OS2 is defined at one side of the optical lens OL to face the first light incident surface LS1, and the third optical surface OS3 is defined at the other side of the optical lens OL to face the second light incident surface LS2.

When viewed in a cross-sectional view, each of the second and third optical surfaces OS2 and OS3 is inclined with respect to the light exit surface LS3. Thus, as shown in FIG. 3C, the light exiting through the light exit surface LS3 is incident to the inside of the optical lens OL through the first optical surface OS1 and can be reflected by the second and third optical surfaces OS2 and OS3 within the optical lens OL. Then, the reflected light passes through the optical lens OL to fall incident upon the first and second light guiding parts GP1 and GP2 through the first and second light incident surfaces LS1 and LS2.

The light guiding member 550 guides the light provided from the light sources LP to the display panel 520, and the light guiding member 550 is divided into multiple parts. The light guiding member 550 includes the first light guiding part GP1 and the second light guiding part GP2 spaced apart from the first light guiding part GP1.

The first light guiding part GP1 has a flat shape and is disposed at one side of the light sources LP. The second light guiding part GP2 has a flat shape and is disposed at the other side of the light sources LP. Thus, the second light guiding part GP2 is spaced apart from the first light guiding part GP1 such that the light sources LP are disposed between the first light guiding part GP1 and the second light guiding part GP2.

In the present exemplary embodiment, each of the first and second light guiding parts GP1 and GP2 has a wedge shape.

More particularly, as shown in FIG. 3A, each of the first and second light guiding parts GP1 and GP2 has a thickness that decreases as a distance from the respective first and second edge parts EP1-1 and EP2-1 decreases. The first light guiding part GP1 includes the first light incident surface LS1 and a first opposite surface LS1-1 facing the first light incident surface LS1. The thickness of the first light guiding part GP1 increases as a distance from the first light incident surface LS1 decreases, and the thickness of the first light guiding part GP1 is reduced as a distance from the first opposite surface LS1-1 decreases. The second light guiding part GP2 includes the second light incident surface LS2 and a second opposite surface LS2-1 facing the second light incident surface LS2. The thickness of the second light guiding part GP2 increases as a distance from the second light incident surface LS2 decreases, and the thickness of the second light guiding part GP2 is reduced as a distance from the second opposite surface LS2-1 decreases.

The reflection plate 570 is accommodated in the accommodating member 580. The reflection plate 570 is optically reflective and reflects the light emitted from the light sources LP toward the light guiding member 550.

The reflection plate 570 may be divided into multiple parts. In the present exemplary embodiment, the reflection plate 570 includes a first reflection part RP1 and a second reflection part RP2 spaced apart from the first reflection part RP1. The first reflection part RP1 is disposed between the first bottom portion CP1 and the first light guiding part GP1, and the second reflection part RP2 is disposed between the second bottom portion CP2 and the second light guiding part GP2.

According to another embodiment, the reflection plate 570 may further include a center reflection part (not shown) connecting the first reflection part RP1 and the second reflection part RP2. In this case, the center reflection part is disposed between the printed circuit board PB and the center bottom portion CP3.

The optical member 540 is disposed between the display panel 520 and the light guiding member 550, and controls a path of the light incident to the display panel 520 after being emitted from the light guiding member 550.

The optical member 540 includes a plurality of optical sheets. For instance, the optical member 540 includes a diffusion sheet and a prism sheet. Any number and types of optical sheets may be included. The optical member 540 diffuses and condenses the light exiting from the light guiding member 550 and traveling to the display panel 520.

However, the type of the optical member 540 should not be limited thereto or thereby. That is, the optical member 540 may be, for example, a diffusion plate, a reflective polarizing plate, or a phase difference plate.

A frame member 530 supports edges of the optical member 540 and edges of the display panel 520, and is coupled to the accommodating member 580. Thus, the edges of the optical member 540 and the edges of the display panel 520 are fixed to the accommodating member 580 by the frame member 530.

The frame member 530 includes a plurality of frames (e.g., sides), and frames corresponding to the long sides of the display panel 520 are bent in the first direction DR1 to correspond to the curved shape of the display panel 520. Frame member 530 is a rigid, bent member shaped according to the desired amount by which the display panel 520 is to be bent.

A reflection member RM overlaps the area between the first light guiding part GP1 and the second light guiding part GP2 to cover the light sources LP. The reflection member RM extends in the second direction DR2 similar to the printed circuit board PB, and the reflection member RM also covers an end portion of the first light guiding part GP1 and an end portion of the second light guiding part GP2, which face each other. Therefore, the reflection member RM prevents light from leaking out between the first and second light guiding parts GP1 and GP2, and the light reflected by the reflection member RM is incident to the first and second light guiding parts GP1 and GP2.

As shown in FIG. 3A, the supporting members SM are disposed between the reflection member RM and the optical member 540 to support a rear surface of the optical member 540. The supporting members SM maintain a more uniform distance between the optical member 540 and the reflection member RM. As a result, the supporting members SM prevent the optical member 540 from being pushed back toward the reflection member RM.

In the present exemplary embodiment, the supporting members SM are arranged on the reflection member RM to be spaced apart from each other, and the supporting members SM include a material having elasticity and being optically transmissive, e.g., silicon.

The covering member 510 covers edge parts of the display panel 520, e.g., the first edge part EP1-1 and the second edge part EP2-1. The covering member 510 is coupled to the frame member 530, and the covering member 510 and the frame member 530 support the edge parts of the display panel 520. Therefore, the curved shape of the display panel 520 is maintained by the covering member 510 and the frame member 530.

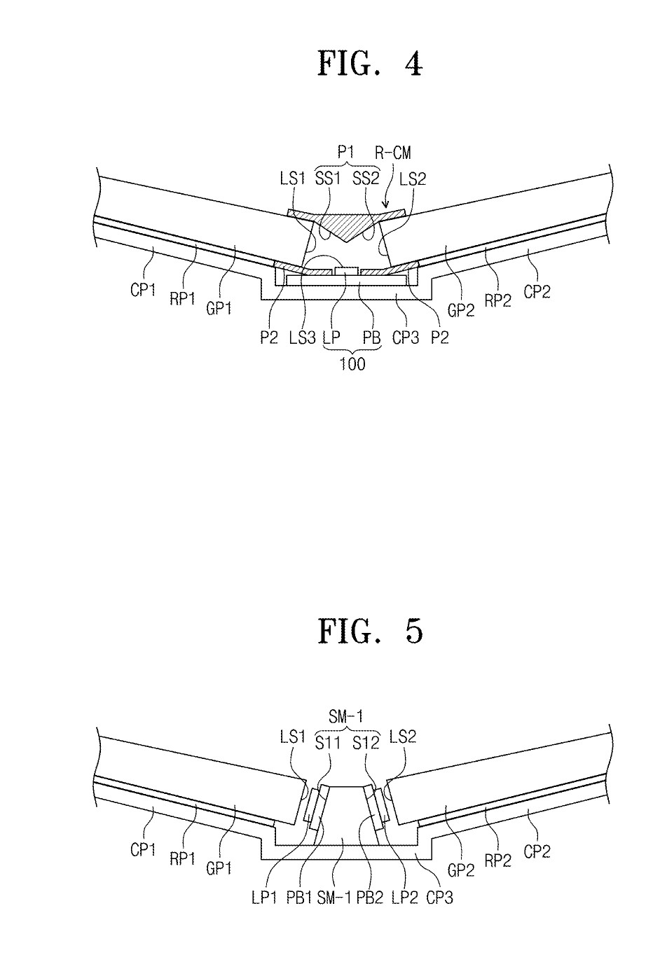

FIG. 4 is a cross-sectional view showing a light emitting unit and a light guiding member of a curved display device according to another exemplary embodiment of the present disclosure. In FIG. 4, the same reference numerals denote the same elements in FIGS. 1A, 1B, 2, and 3A to 3C, and thus any further detailed descriptions of the same elements will be omitted.

In the exemplary embodiment shown in FIG. 3A, the optical lens OL (refer to FIG. 3A) is disposed in the area between the first light guiding part GP1 and the second light guiding part GP2. However, in the present exemplary embodiment shown in FIG. 4, a reflective covering member R-CM is disposed in an area between a first light guiding part GP1 and a second light guiding part GP2.

The reflective covering member R-CM is optically reflective, i.e. reflects visible light, so that it reflects light emitted from light sources LP toward the first and second light guiding parts GP1 and GP2.

The reflective covering member R-CM includes a first covering part P1 and a second covering part P2. The first covering part P1 covers upper end portions of the first and second light guiding parts GP1 and GP2 which face each other, and the first covering part P1 overlaps the area between the first and second light guiding parts GP1 and GP2 to cover the light sources LP. In addition, a first reflection surface SS1 and a second reflection surface SS2 are defined on the first covering part P1, and each of the first and second reflection surfaces SS1 and SS2 is inclined with respect to a light exit surface LS3 of the light sources LP when viewed in a side view.

The second covering part P2 covers lower end portions of the first and second light guiding parts GP1 and GP2 which face each other. A plurality of holes is formed through the second covering part P2 to correspond to positions of the light sources LP in a one-to-one correspondence, and the light sources LP are inserted into the holes. Thus, the light exit surfaces LS3 of the light sources LP are exposed to a space surrounded and defined by the first light incident surface LS1, the second light incident surface LS2, and the reflective covering member R-CM.

According to the structure of the reflective covering member R-CM described above, the light emitted from the light sources LP is incident to the first and second light guiding parts GP1 and GP2 through the first and second light incident surfaces LS1 and LS2, sometimes after being reflected by the first and second reflection surfaces SS1 and SS2. Also, since the light sources LP are surrounded by the reflective covering member R-CM, the reflective covering member R-CM prevents the light from leaking through the area between the first and second light guiding parts GP1 and GP2.

FIG. 5 is a cross-sectional view showing a light emitting unit and a light guiding member of a curved display device according to another exemplary embodiment of the present disclosure. In FIG. 5, the same reference numerals denote the same elements described in previous embodiments, and thus any additional detailed descriptions of the same elements will be omitted.

In the present exemplary embodiment shown in FIG. 5, instead of the optical lens OL (refer to FIG. 3A), an auxiliary supporting member SM-1 is disposed in an area between first and second light guiding parts GP1 and GP2.

The auxiliary supporting member SM-1 is disposed on the center bottom portion CP3. The auxiliary supporting member SM-1 includes a first inclination surface S11 and a second inclination surface S12, which are both inclined with respect to the center bottom portion CP3. The first inclination surface S11 faces a first light incident surface LS1 of the first light guiding part GP1, and the second inclination surface S12 faces a second light incident surface LS2 of the second light guiding part GP2. Here, surface S11 is substantially parallel to surface LS1, and surface S12 is substantially parallel to surface LS2.

In the present exemplary embodiment, a first printed circuit board PB1 is disposed on the first inclination surface S11, and a second printed circuit board PB2 is disposed on the second inclination surface S12. In addition, first light sources LP1 are disposed on the first printed circuit board PB1, and second light sources LP2 are disposed on the second printed circuit board PB2.

As described above with reference to FIG. 3C, when the first and second light sources LP1 and LP2 have top emission type structures, a light exit surface of the each of the first light sources LP1 faces the first light incident surface LS1 of the first light guiding part GP1 and a light exit surface of each of the second light sources LP2 faces the second light incident surface LS2 of the second light guiding part GP2.

Therefore, the light emitted from the first and second light sources LP1 and LP2 more directly travels to the respective first and second light incident surfaces LS1 and LS2, to fall incident upon the first and second light guiding parts GP1 and GP2. This reduces or eliminates the need for a separate optical element which controls a path of the light emitted from the first and second light sources LP1 and LP2.

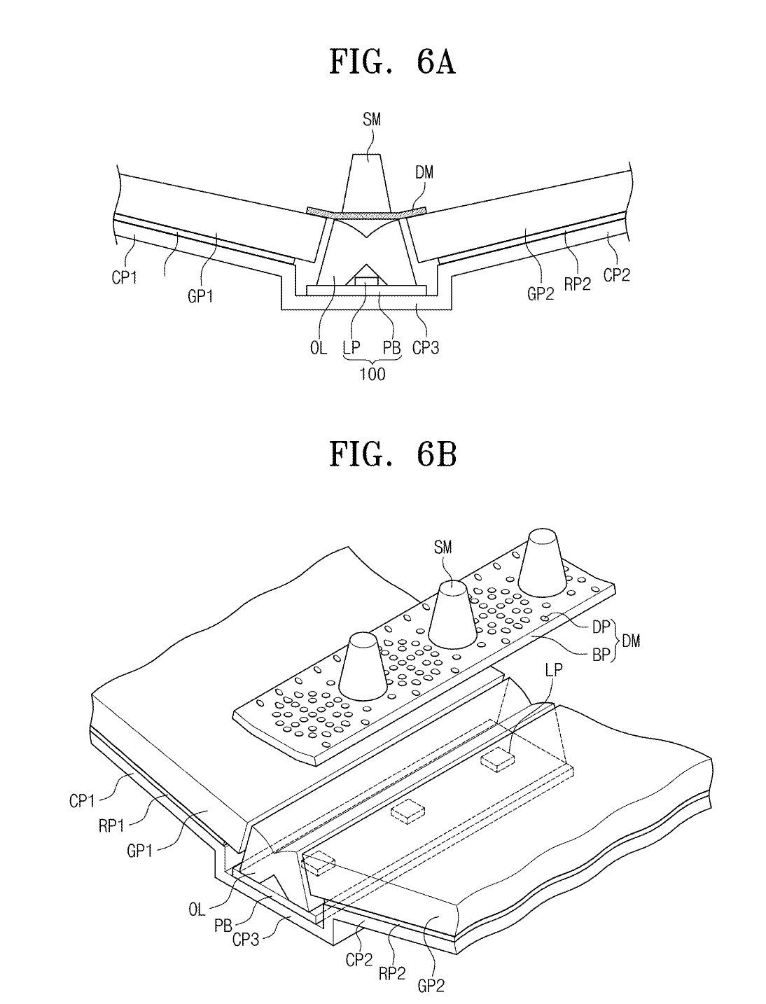

FIGS. 6A and 6B are views showing a light emitting unit and a light guiding member of a curved display device according to another exemplary embodiment of the present disclosure. In FIGS. 6A and 6B, the same reference numerals denote the same elements described in previous embodiments, and thus any redundant detailed descriptions of the same elements will be omitted.

Referring to FIGS. 6A and 6B, instead of the reflection member RM (refer to FIG. 3C), a diffusion member DM is disposed on the end portions of first and second light guiding parts GP1 and GP2 which face each other. The diffusion member DM overlaps an area between the first and second light guiding parts GP1 and GP2 to cover a plurality of light sources LP.

Therefore, light that leaks through the area between the first and second light guiding parts GP1 and GP2 is diffused by the diffusion member DM. Thus, a visible bright line having a higher brightness than that of surrounding areas, and which is caused by the leaked light, is prevented from occurring in the display panel 520 (refer to FIG. 3A).

The diffusion member DM includes a base part BP and light scattering parts DP disposed on the base part BP. The base part BP includes an optically transmissive plastic such as polymethylmetacrylate (PMMA), polycarbonate (PC), and polystyrene (PS), etc., and the light scattering parts DP include an optically semi-transmissive material, such as titanium dioxide.

In the present exemplary embodiment, a spatial density of the light scattering parts DP varies according to the position of the light sources LP. In more detail, the density of the light scattering parts DP is greater in first areas over the light sources LP, and lower in second areas outside the first areas.

As a result, a diffusion function of the diffusion member DM is improved more in the first area than in the second area, and a bright line having a higher brightness than surrounding areas is prevented from occurring in areas corresponding to the position of the light sources LP in the display panel 520.

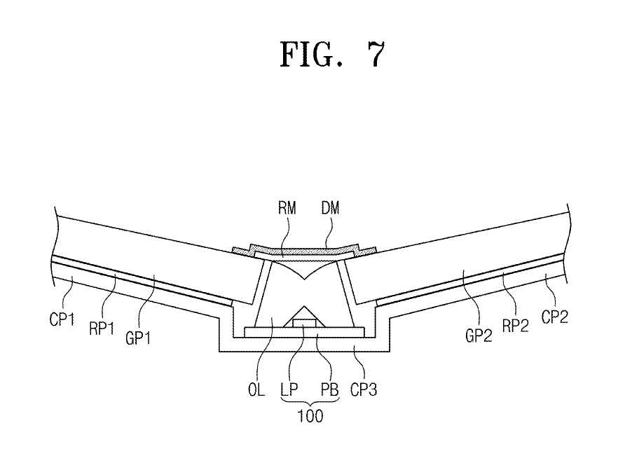

FIG. 7 is a cross-sectional view showing a light emitting unit and a light guiding member of a curved display device according to another exemplary embodiment of the present disclosure. In FIG. 7, the same reference numerals denote the same elements described in previous embodiments, and thus any redundant descriptions of the same elements will be omitted.

Referring to FIG. 7, the reflection member RM described with reference to FIG. 3C and the diffusion member DM described with reference to FIG. 6A cover the area between a first light guiding part GP1 and a second light guiding part GP2 in the present exemplary embodiment.

Thus, the reflection member RM reflects light that leaks out through the area between first and second light guiding parts GP1 and GP2. In addition, any remaining leaked light is diffused by the diffusion member DM. As a result, a bright dot or a bright line, which have a higher brightness than surrounding areas, is prevented from occurring in the display panel 520.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Various features of the above described and other embodiments can be mixed and matched in any manner, to produce further embodiments consistent with the invention.

What is claimed is:

1. A curved display device comprising:
a display panel having a curved shape and comprising a display area having a curved surface; and
a backlight assembly arranged to provide light to the display panel, the backlight assembly comprising:
at least one light source arranged to emit the light; and
a light guiding member positioned and arranged to guide the light to the display panel, the light guiding member comprising at least two light guiding parts spaced apart from each other with a gap therebetween, the light source being disposed in the gap.

2. The curved display device of claim 1, wherein the two light guiding parts comprise:
a first light guiding part disposed at one side of the light source; and
a second light guiding part disposed at an opposing side of the light source.

3. The curved display device of claim 2, wherein each of the first and second light guiding parts comprises a light incident surface and an opposite surface facing the light incident surface, and each of the first and second light guiding parts has a thickness that decreases as a distance from the opposite surface decreases.

4. The curved display device of claim 2, wherein each of the first and second light guiding parts comprises substantially flat surfaces.

5. The curved display device of claim 4, wherein each of the first and second light guiding parts is positioned so as to form an included angle that is an oblique angle.

6. The curved display device of claim 4, wherein the display panel has the curved shape bent along a first direction and each of the first and second light guiding parts is substantially parallel to a direction oblique to the first direction when viewed in a side view.

7. The curved display device of claim 2, wherein the backlight assembly comprises:
a printed circuit board on which the light source is mounted; and
an accommodating member accommodating the light source, the light guiding member, and the printed circuit board,
wherein the printed circuit board overlaps an area between the first light guiding part and the second light guiding part.

8. The curved display device of claim 7, wherein the accommodating member comprises bottom portions and a plurality of sidewalls extending from the bottom portions, the bottom portions comprising:
a first bottom portion facing the first light guiding part;
a second bottom portion facing the second light guiding part; and
a center bottom portion connecting the first bottom portion to the second bottom portion, the center bottom portion facing the printed circuit board.

9. The curved display device of claim 8, wherein each of the first and second bottom portions is inclined with respect to the center bottom portion so as to form an included angle between the first and second bottom portions, the included angle being an oblique angle.

10. The curved display device of claim 8, wherein the display panel has the curved shape bent along a first direction and each of the first and second bottom portions is substantially parallel to a direction oblique to the first direction when viewed in a side view.

11. The curved display device of claim 8, wherein the backlight assembly further comprises a reflection plate disposed between the accommodating member and the light guiding member, the reflection plate comprising:
a first reflection part disposed between the first bottom portion and the first light guiding part; and
a second reflection part disposed between the second bottom portion and the second light guiding part.

12. The curved display device of claim 2, wherein the backlight assembly further comprises at least one optical member, the at least one optical member being disposed between the display panel and the light guiding member to have the curved shape and being arranged to direct light exiting from the light guiding member and incident to the display panel.

13. The curved display device of claim 12, wherein the backlight assembly further comprises:
a reflection member overlapping an area between the first light guiding part and the second light guiding part to cover the light source; and
a supporting member disposed between the reflection member and the optical member to support the optical member.

14. The curved display device of claim 7, wherein the backlight assembly further comprises:
an optical lens disposed in the gap between the first light guiding part and the second light guiding part, so as to cover the light source and to be arranged to refract the light toward the first and second light guiding parts; and
a reflection member overlapping the gap, so as to cover the optical lens.

15. The curved display device of claim 7:
wherein the backlight assembly further comprises a reflective covering member, and
wherein the reflective covering member covers edges of the first and second light guiding parts which face each other, and comprises a reflection surface inclined with respect to a light exit surface of the light source so as to reflect the light emitted from the light source toward the first and second light guiding parts.

16. The curved display device of claim 7:
wherein the backlight assembly further comprises:
an auxiliary supporting member disposed in the gap; and
a reflection member overlapping the gap so as to cover the light source, and
wherein the auxiliary supporting member comprises an inclined surface facing a surface of the light guiding member, and the printed circuit board is disposed on the inclined surface.

17. The curved display device of claim 7, wherein the backlight assembly further comprises a diffusion member covering ends of the first and second light guiding parts which face each other.

18. The curved display device of claim 17, wherein the diffusion member comprises a base part and light scattering parts disposed on the base part, and a spatial density of the light scattering parts in a first area of the base part corresponding to a position of the light source is greater than a spatial density of the light scattering parts in an area of the base part outside the first area.

19. A curved display device comprising:
a display panel having a curved shape and comprising a display area having a curved surface; and
a backlight assembly arranged to provide light to the display panel, the backlight assembly comprising:
a plurality of light sources arranged substantially parallel to a side of the display panel and constructed to emit the light; and
a light guiding member positioned and arranged to guide the light to the display panel, wherein the light guiding member has a thickness that decreases with distance from the plurality of light sources.

20. The curved display device of claim 19, wherein the light guiding member comprises:
a first light guiding part having a flat shape and disposed at one side of the light sources; and
a second light guiding part having a flat shape and disposed at an opposing side of the light sources,
wherein each of the first and second light guiding parts comprises a light incident surface and an opposite surface facing the light incident surface, and a thickness of each of the first and second light guiding parts decreases as a distance from its corresponding opposite surface decreases.

21. The curved display device of claim 20, wherein each of the first and second light guiding parts is positioned so as to form an included angle that is an oblique angle.

22. The curved display device of claim 20, wherein the display panel has the curved shape bent along a first direction and each of the first and second light guiding parts is substantially parallel to a direction oblique to the first direction when viewed in a side view.

23. The curved display device of claim 20, wherein the backlight assembly further comprises:
a printed circuit board having the light sources mounted thereon and overlapping an area between the first light guiding part and the second light guiding part; and
an accommodating member accommodating the light sources, the light guiding member, and the printed circuit board,
wherein the accommodating member comprises:
a first bottom portion facing the first light guiding part;
a second bottom portion facing the second light guiding part; and
a center bottom portion connecting the first bottom portion to the second bottom portion and facing the printed circuit board.

24. The curved display device of claim 23, wherein each of the first and second bottom portions is inclined with respect to the center bottom portion.

25. The curved display device of claim 23, wherein the backlight assembly further comprises a reflection plate disposed between the bottom portions of the accommodating member and the light guiding member, the reflection plate comprising:
a first reflection part disposed between the first bottom portion and the first light guiding part; and
a second reflection part disposed between the second bottom portion and the second light guiding part.

26. The curved display device of claim 20, wherein the backlight assembly further comprises:
at least one optical member disposed between the display panel and the light guiding member to have the curved shape and being arranged to direct the light exiting from the light guiding member and incident to the display panel;
a reflection member overlapping an area between the first light guiding part and the second light guiding part to cover the light sources; and
a supporting member disposed between the reflection member and the optical member to support the optical member.
